(19) United States
(12) Patent Application Publication
(10) Pub. No.: US 2026/0305701 A1
(43) Pub. Date: Oct. 8, 2026

(54) AEROSOL PROVISION SYSTEM

(71) Applicant: Nicoventures Trading Limited, London (GB)

(72) Inventor: Junior KABIRAT, London (GB)

(21) Appl. No.: 19/713,149

(22) Filed: Jun. 18, 2026

Related U.S. Application Data
(63) Continuation of application No. 17/780,137, filed on Nov. 27, 2020.

(30) Foreign Application Priority Data
Nov. 29, 2019 (GB) 1917482.0

(51) Int. Cl. A24F 40/46; A24F 40/50; A24F 40/65

(52) U.S. Cl. CPC A24F 40/46; A24F 40/50; A24F 40/65

(57) ABSTRACT

An aerosol provision (AP) system is disclosed comprising a consumable comprising a plurality of aerosol generating material portions and an aerosol generator operable to generate an aerosolised payload by providing a predetermined heating profile to at least one of the plurality of aerosol generating material portions. The predetermined heating profile is at least one of: (i) pre-programmed in a controller of the AP system; and (ii) selected based on a coded portion of the consumable.

### CROSS-REFERENCE TO RELATED APPLICATIONS

This application is a Continuation of U.S. patent application Ser. No. 17/780,137 filed May 26, 2022, which is a National Phase entry of PCT Application No. PCT/EP2020/083807, filed Nov. 27, 2020, which claims priority from Great Britain Application No. 1917482.0, filed Nov. 29, 2019, each of which are fully incorporated herein by reference in their entireties.

### TECHNICAL FIELD

The present invention relates to an aerosol provision system, a consumable for use in an aerosol provision system, a method of providing an aerosol and an aerosol provision means.

### BACKGROUND

Aerosol provision systems are known. Common systems use heaters to create an aerosol from a suitable medium which is then inhaled by a user. Often the medium used needs to be replaced or changed to provide a different aerosol for inhalation. This can lead to a user needing to open the system or to access inner components of the system. Personalised aerosols are not provided by common aerosol provision systems.

The present invention is directed toward solving or mitigating some of the above identified issues.

### SUMMARY

Aspects of the invention are defined in the accompanying claims.

In accordance with a first aspect described herein, there is provided an aerosol provision (AP) system comprising: a consumable comprising a plurality of aerosol generating material portions; an aerosol generator operable to generate an aerosolised payload by providing a predetermined heating profile to at least one of the plurality of aerosol generating material portions, wherein the predetermined heating profile is at least one of: pre-programmed in a controller of the AP system; and selected based on a coded portion of the consumable.

In an embodiment, the aerosol generator provides a first predetermined heating profile to a first aerosol generating material portion and a second predetermined heating profile to a second aerosol generating material portion, wherein the first predetermined heating profile is different to the second predetermined heating profile.

In an embodiment, the first predetermined heating profile heats at a first power level and the second predetermined heating profile heats at a second power level, wherein the first power level and the second power level are different power levels.

In an embodiment, the first predetermined heating profile heats for a first time period and the second predetermined heating profile heats for a second time period, wherein the first time period and the second time period are different time periods.

In an embodiment, the first predetermined heating profile heats according to first heating curve and the second predetermined heating profile heats according to second heating curve, wherein the first heating curve and the second heating curve are different heating curves.

In an embodiment, one of the first predetermined heating profile and the second predetermined heating profile is pre-programmed in a controller of the AP system and the other of the first predetermined heating profile and the second predetermined heating profile is selected based on a coded portion of the consumable.

In an embodiment, there is provided a container for aerosol generating material, the container arranged to removably receive aerosol generating material.

In an embodiment, the container is arranged to removably receive aerosol generating material in a cartridge.

In an embodiment, the container is arranged to removably receive a plurality of cartridges.

In an embodiment, the consumable comprises a plurality of coded portions, and wherein the predetermined heating profile is at least one of: pre-programmed in a controller of the AP system; and selected based on one of a plurality of coded portions of the consumable.

In an embodiment, there is provided a system, comprising: the AP system of any one of the preceding claims, and a cartridge comprising aerosol generating material. The system arranged to: detect the presence of the cartridge in the AP system; program a predetermined heating profile; and heat the aerosol generating material with the predetermined heating profile to produce an aerosol.

In accordance with a second aspect described herein, there is provided a consumable for use in an aerosol provision (AP) system, comprising: a carrier support; aerosol generating material; and a coded portion containing coded information relating to a predetermined heating profile for use with the consumable.

In one embodiment, there is provided a plurality of aerosol generating materials.

In one embodiment, the consumable further comprises a corresponding plurality of coded portions relating to each of the plurality of aerosol generating materials.

In accordance with a third aspect described herein, there is provided a method of providing an aerosol, comprising: detecting the presence of a cartridge in a AP system; programming a predetermined heating profile; and heating aerosol generating material in the cartridge with the predetermined heating profile to produce an aerosol. In one embodiment, detecting the presence of the cartridge in the AP system comprises detecting a coded portion on the cartridge, and programming a predetermined heating profile comprises programming a predetermined heating profile corresponding to the coded portion on the cartridge.

In accordance with a fourth aspect described herein, there is provided an aerosol provision (AP) means, comprising: a consumable comprising a plurality of aerosol generating material portions, comprising aerosol generating means operable to generate an aerosolised payload by providing a predetermined heating profile to at least one of the plurality of aerosol generating material portions. The predetermined heating profile is at least one of: pre-programmed in a controlling means of the AP means; and selected based on a coded portion of the consumable.

### DESCRIPTION OF DRAWINGS

The present teachings will now be described by way of example only with reference to the following figures in which like parts are depicted by like reference numerals:

FIG. 1 is a schematic sectional view of an aerosol provision system according to an example;

FIG. 2 is a schematic sectional view of an aerosol provision system according to an example;

FIG. 3 is a schematic sectional view of an aerosol provision system according to an example; and,

FIG. 4 is a schematic sectional view of an aerosol provision system according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

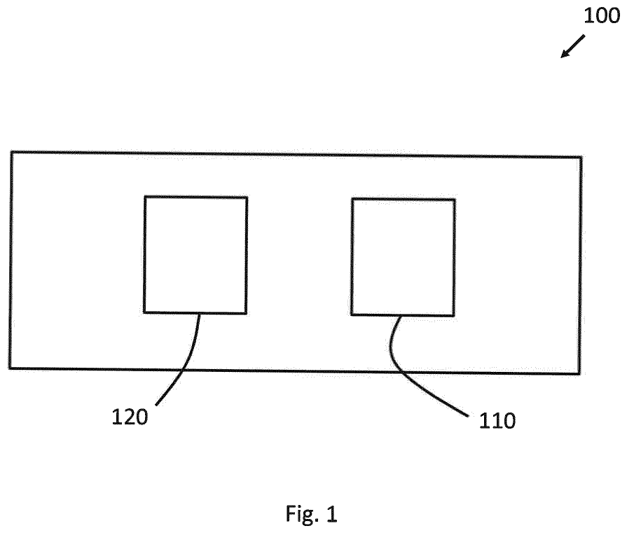

FIG. 1 illustrates a schematic view of an aerosol provision (AP) system 100. The AP system 100 is for generating an aerosol for inhalation by a user. The AP system 100 as illustrated in this example may be designed to simulate a cigarette and therefore as a non-limiting example may have a substantially cylindrical shape and be approximately the same size as a cigarette. In other embodiments, AP system 1 may have a different shape, such as a substantially planar shape, a substantially cuboid shape, a substantially spherical shape, a trapezoidal shape, or other shape.

The AP system 100 has a consumable 110 and an aerosol generator 120. The consumable 110 has a plurality of aerosol generating material portions. The aerosol generator 120 is operable to generate an aerosolised payload by providing a predetermined heating profile to at least one of the plurality of aerosol generating material portions. In an example, the predetermined heating profile may be pre-programmed in a controller of the AP system 100. In an example, the predetermined heating profile is selected based on a coded portion of the consumable 110. In an example, the AP system may be provided with a controller wherein the controller already comprises a predetermined heating profile pre-programmed within it. Alternatively, in an example a user may select the predetermined heating profile prior to use, such that the predetermined heating profile may be pre-programmed in a controller of the AP system 100 prior to use. A user selecting the predetermined heating profile prior to use may comprise the user selecting one or more heating profile parameters, such that the predetermined heating profile is created according to the selected one or more heating profile parameters. The user may select or create a different predetermined heating profile prior to each use. In an example, the controller of the AP system 100 comprises a memory and a processor, wherein the heating profile pre-programmed in the controller comprises the heating profile being stored on the memory. In an example, the memory comprises a local memory, or a remote memory wherein the controller is comprises communication means to access the remote memory.

The consumable 110 may be loaded into the AP system 100 prior to use. Alternatively, the consumable 110 may be provided as an integral part of the AP system 100 and the AP system 100 may be discarded after the consumable 110 is depleted.

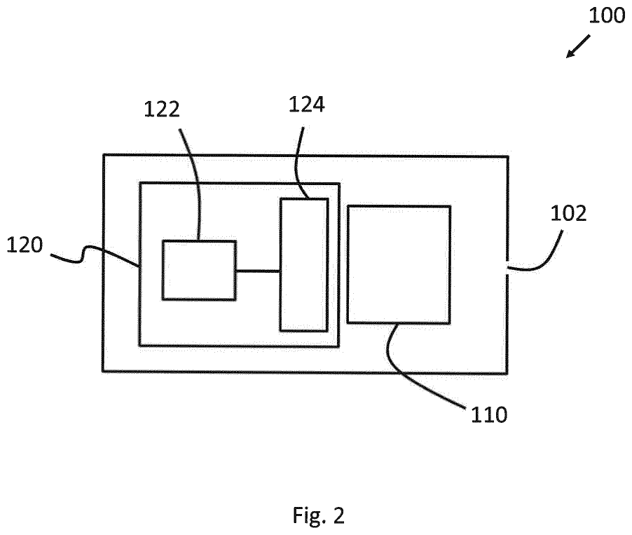

FIG. 2 illustrates a schematic view of an AP system 100. The AP system 100 has a consumable 100 and an aerosol generator 120. The AP system 100 also has an outlet 102 through which an aerosol may pass.

The aerosol generator 120 as shown in the example of FIG. 2 includes a controller 122 in which a predetermined heating profile may be pre-programmed. This heating profile may be used in heating the consumable 110 when the AP system 100 is initially activated or in response to a particular type of consumable 110. The controller 122 is connected to a heater 124. The heater 124 may be an electrical resistive heater, an inductive heater, a chemical heater or any related elements of those heater systems. The heater 124 provides energy to the consumable 110 to generate an aerosol from the consumable. The heater 124 may heat any or select portions contained within the aerosol generating material portions. The controller 122 may send signals to the heater 124 to control the heating profile provided to the consumable 110 by the heater 124.

The heater 124 may comprise one or more electrically resistive heaters, including for example one or more nichrome resistive heater(s) and/or one or more ceramic heater(s). The one or more heaters may comprise one or more induction heaters which includes one or more susceptors which may form a chamber into which a consumable 110 comprising aerosol generating material portions is inserted or otherwise located in use. Alternatively, the one or more susceptors may be positioned near or adjacent a consumable 110 comprising aerosol generating material portions located in use Alternatively or in addition, one or more susceptors may be provided in one or more of the aerosol generating material portions. In one example, one or more susceptors may be provided elsewhere in the consumable, such as adjacent one or more of the aerosol generating material portions. Other heating arrangements may also be used.

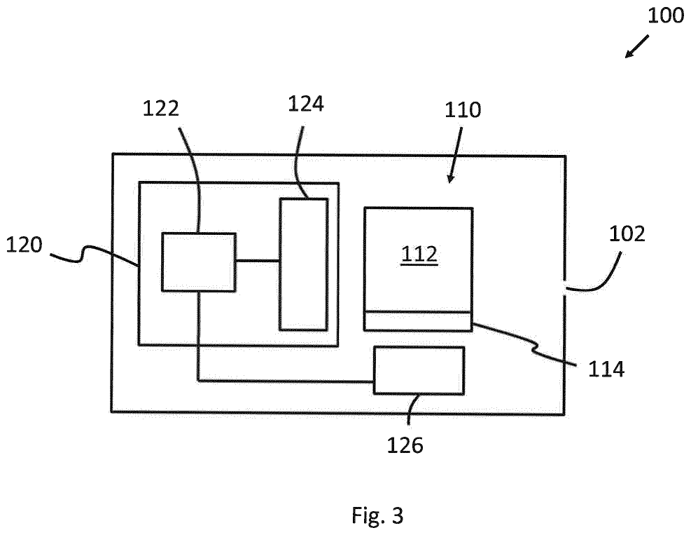

FIG. 3 illustrates a schematic view of an AP system 100. The AP system 100 has a consumable 110 and an aerosol generator 120. The AP system 100 has an outlet 102.

The consumable 110, in the example shown in FIG. 3, comprises an aerosol generating material portion 112. The consumable 110 may have a plurality of aerosol generating material portions 112. The aerosol generating material portion or portions (where relevant) 112 may be any of tobacco, a nicotine containing material, menthol, an acid containing gel (for controlling protonation), glycerol etc. Other materials may be of different flavours. In an example, nicotine within the aerosol generating material 112 is heated to provide nicotine to the aerosol and glycerol within the aerosol generating material 112 is heated accordingly to provide a desired cloud volume. Varying the heating provided to acid within the aerosol generating material 112 alters the level of protonation of the nicotine (in the event that nicotine is also heated).

The nicotine material within the aerosol generating material 112 may contain any of a nicotine free base, nicotine benzoate, nicotine malate, nicotine pyruvate, and nicotine succinate.

The consumable 110 as shown in the example of FIG. 3 also has a coded portion 114. The coded portion 114 contains a code that may indicate to the aerosol generator 120 an appropriate heating profile for use with the consumable 110. The coded portion 114 may be a bar code, QR code, an identifiable colour code, or the like. In an example, the consumable 110 comprises a one or more susceptors comprising the coded portion 114. The code may be encoded in a response of the one or more susceptors to one or more induction heaters. For example, the one or more induction heaters may comprise one or more magnetic field generators for generating a varying magnetic field, such that the response of the one or more susceptors is a response arising from an interaction between the one or more susceptors and the varying magnetic field. The coded portion 114 may be read by a sensor or reader or the like which sends a signal to the aerosol generator 120.

The AP system 100 of FIG. 3 has a sensor or reader 126 for detecting the coded portion 114 of the consumable 110 and sending a signal to the controller 122. The sensor 126 may be part of the aerosol generator 120. The sensor 126 of FIG. 3 is shown connected to the controller 122 of the aerosol generator 120. In an example, the sensor 126 detects the coded portion 114 of the consumable and sends a signal to the controller 122. The controller 122 then signals to the heater 124 to generate a heating profile suitable to the aerosol generating material portion 112. The heater 124 then heats the aerosol generating material portion or portions 112 in the consumable to produce an aerosol which flows through the outlet 102 and is suitable for inhalation by a user.

The sensor may be a bar code reader, a QR code reader, an IR detector, an RFID detector, an optical sensor or the like. The sensor in the AP system 100 may recognise when the consumable 110 is placed within and removed from the system 100. The AP system 100 may be prevented from operation when the system 100 has no consumable within the system 100 as a safety precaution. This will also prevent the system 100 from being used with non-authentic consumables 110 as the sensor will not signal to the controller to allow the AP system 100 to operate as the sensor will not recognise the consumable 110 without an authentic coded portion 114. This advantageous protects the system 100 from misuse with non-authentic consumables 110 which may extend the lifetime of the system 100.

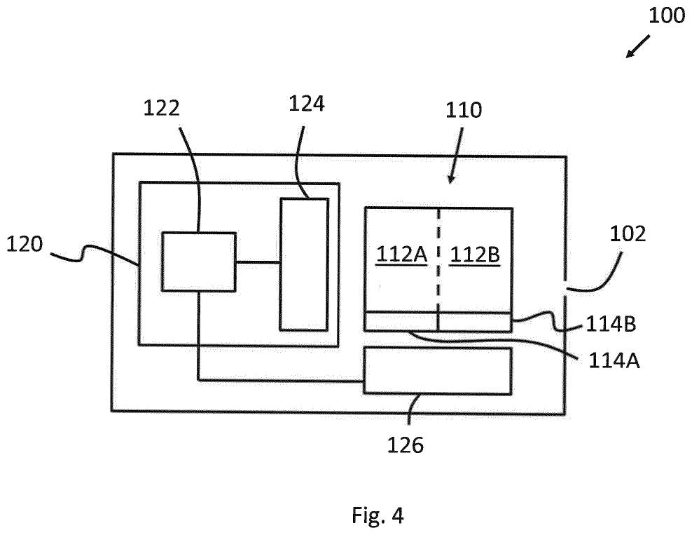

FIG. 4 illustrates a schematic view of an AP system 100. The consumable 110 shown in the example of FIG. 4 has two portions of aerosol generating material 112A, 112B and the consumable 110 has two coded portions 114A, 114B. One coded portion 114A corresponds to one of the aerosol generating material portions 112A, and the other coded portion 114B corresponds to the other aerosol generating material portion 112B.

One of the portions of aerosol generating material may be a first aerosol generating material and the other portion may be a second aerosol generating material wherein the two aerosol generating materials are different. In an example, one aerosol generating material may be a nicotine containing compound such as tobacco and the other aerosol generating material may be menthol or the like.

In an example, there may be a number of coded portions 114A, 114B equivalent to the number of portions 112A, 112B of aerosol generating material in the consumable 110. Each coded portion 114A, 114B may be detected prior to heating of the aerosol generating material in the consumable 110. In another example, there may be fewer coded portions 114A, 114B than portions 112A, 112B of aerosol generating material in the consumable. Certain coded portions 114A, 114B may be the same, in that a subset of coded portions may the same where each refers to a portion of aerosol generating material that requires the same heating profile. A different subset of coded portions 114A, 114B may relate to portions of aerosol generating material that require a different heating profile to provide an aerosol.

Different coded portions 114A, 114B may signal to the heater 124 to provide different heating profiles to the aerosol generating material. Certain different coded portions 114A, 114B may however lead to the same heating profiles being provided, if for example a predetermined heating profile is suitable for heating both a flavourant portion and a menthol portion of aerosol generating material.

The sensor 126 may detect that the consumable 110 has two coded portions 114A, 114B and signal to the controller that a heating profile suitable for that particular consumable is to be used during the smoking session involving this consumable 110.

The AP system 100 of the present disclosure may have a power source and activation mechanism etc., however these are not displayed in the Figures. The power source may be any suitable power source but may include a battery or the like. Activation mechanism may be any suitable activation mechanism such as a button which is pressed by a user prior to, or during, use to initiate the aerosol generator 120 or a puff detector which detects when the user is inhaling and therefore initiates the aerosol generator 120.

The default predetermined heating profile delivered by the AP system 100 may be a standard heating profile in the sense that it delivers a manufacturer-defined “standard” user experience from an associated consumable 110. This “standard” user experience may be based on the median user experience desired from such an AP system 100. Use of a default predetermined heating profile removes the requirement on the user to specify their preferences on a device with which the user may not have a great level of familiarity. In this way, the default heating profile enables a user to “plug and play” and begin using the device comfortably as soon as they have the device.

As the user grows in familiarity with the device, the user may wish to personalise, i.e. amend, the default setting and there may be an input section on the device for enabling a user to personalise the heating profile based on the composition of the aerosol desired by the user. This may be via a user interface on the device such as a touch screen or the like on the AP system 100, or may be via a wired or wireless communication to the device. The AP system 100 may be operated via e.g. BlueTooth® or a LAN or via a smartphone or other such device.

The personalisation may be for the heating profile delivered to the aerosol generating material 112 during one puff or may be over a series of puffs. In an example, the user may opt for the heating profile for the first puff to remain as the default predetermined heating profile but opt to edit the heating profile for subsequent puffs. A smoking session typically includes 12 or more puffs and therefore the heating profile for each puff may be the same or different and each heating profile may be personalised by the user.

The default predetermined heating profile may vary depending on the code (in examples provided by the coded portion 114) detected on the consumable 110. In this way, the user is provided with a suggestion (curated by the manufacturer) for an initial heating profile based on the manufacturer's testing relating to the specific consumable 110 being used in the smoking session. This saves the user manually changing the heating profile each time the user changes the consumable 110 in the AP system 100. In an example, two users may use the same AP system 100. When the first user inserts their consumable 110 in the AP system 100, the aerosol generator 120 prepares and delivers a predetermined heating profile suitable to that consumable 110. The first user may then remove their consumable 110 and the second user may insert their consumable 110. The aerosol generator 120 recognises the change in consumable 110, prepares and delivers a different predetermined heating profile suitable to that new consumable 110. The users therefore are provided with suitable smoking experiences for their consumables. Furthermore, the AP system 100 therefore delivers a suitable heating power during each smoking session. The result is that the AP system 100 efficiently provides aerosol to a user over a large number of consumables 110.

This AP system 100 therefore reduces the likelihood of the delivery of an unsuitable heating profile being delivered to any particular consumable 110. This, in turn, reduces the likelihood of undesired events such as hot puff, dry out, burnt flavours or the lack of production of aerosol (due to a heating profile with not enough heating energy being provided). In this way, the AP system 100 protects important components such as the heater 124 from overheating and therefore increases the lifetime of the AP system 100.

Any factor of the heating profile may be controlled by the controller 122. This includes the heating power, temperature set point, heating time, heating curve, delays between heating and, in the event that multiple heaters are present in the AP system 100, the activation of particular heaters within the AP system 100.

In an example, the consumable contains aerosol generating material in a solid form. The consumable 110 may be in the form of cartridges which are removably insertable into the AP system 100. The AP system 100 described in this example therefore also facilitates changing consumable 110 due to the clean insertion and removing of consumables 110. There is no decantation required when the user wishes to change aerosol generating materials in 112 the AP system 100. Furthermore, the use of cartridges containing different coded portions 114 alongside the present AP system 100 enables multiple users to easily and quickly use the AP system 100 by swapping cartridges in the AP system 100 and having the AP system 100 apply a suitable heating profile to the aerosol generating material 112 of the new cartridge immediately. Use of cartridges in the present AP system 100 removes the need for a user to access the inner of the system 100. Instead, the user may simply insert and remove the cartridge to enable a change of/replenishment in the aerosol generating material 112.

The aerosol generating material 112 may be arranged exclusively on a carrier support. The carrier support may be a surface on one side of which the aerosol generating material 112 is arranged and on the other side of which the coded portion 114 is arranged. The carrier support may be a film or sheet or the like. In the example described above the carrier support has two sides, however there is no requirement for the carrier support to be restricted to such a shape, for example the carrier support may be substantially cylindrical shape, triangular shape, square tube shape or the like. The carrier support in any of these examples may be hollow or solid. In the example wherein the carrier support has a plurality of sides, the aerosol generating material 112 may be constrained to only one side or to all but one side of the carrier support. In an alternate example, the aerosol generating material 112 may be arranged on all sides of the carrier support. The carrier support may be heat conducting so as to carry heat from the heater 124 to the aerosol generating material 112 located on the carrier support. The carrier support may be formed from cardboard or paper or the like.

The AP system 100 may have a heater 124 which comprises a plurality of heating elements. In this example, each of the heating elements may correspond to a particular aerosol generating material within the aerosol generating material 112. For example, if the consumable 110 contains nicotine, glycerol and an acid, each of these may have a particular heating element to provide heat to that particular aerosol generating material 112. This enables further personalisation of the aerosol produced by the AP system 100.

The AP system 100 may have a power chamber (not shown) comprising a power source for supplying power to the heater 124. The heater 124 in the described example may be an electrically resistive heater. However, in other examples, the heater 124 may be a chemically activated heater which may or may not operate via exothermic reactions or the like. The heater 124 may be part of an inductive heating system, wherein the heater 124 is the source of energy for inductive heating, such as a coil of copper wire, and the carrier support may be or may contain a susceptor or the like. The susceptor may for example be a sheet of aluminium foil or the like. In an example, the heating elements are not all the same type of heating element. In an example, at least one heating element of the heater 124 is an electrically resistive heater, another heating element is a chemically activated heater and optionally another heating element is an inductive heater.

In an example, the plurality of aerosol generating materials (nicotine, glycerol, acid) in the aerosol generating material 110 and the plurality of heating elements in the heater 124 may be different in number. For example, one heating element may heat two aerosol generating materials if it is desired for these to always be heated together. Conversely, two heating elements may be used for respective aerosol generating materials in one instance, but may be used in concert to heat a larger quantity of aerosol generating material (for example for a major component of the aerosol, or one that is consumed more frequently) in another instance.

In use, the heating elements of the heater 124 may be activated at the same time or may be operated with a delay between operation. This may be used to enable particular notes of an aerosol to be more or less prevalent in the overall aerosol or smoking session. In an example, a particular heating element may heat a particular material, e.g. tobacco, at a first time to produce a tobacco aerosol for inhalation. This may be shortly followed by a different heating element heating a different material, e.g. menthol at a second time to follow the tobacco aerosol with a menthol aerosol with which the user desires to conclude the smoking session.

Complex combinations of profiles may be utilised to produce a highly specific combination of blends and release time so that the aerosol is highly personalisable.

In an example, a first heating element heats a first material within the aerosol generating material 112 for a first amount of time and a second heating element heats a second material within the aerosol generating material 112 for a second amount of time, wherein the first amount of time and the second amount of time are different. This enables greater personalisation of aerosol. This also enables production of aerosol with different notes during the smoking session. In an example, a nicotine aerosol generating material may be heated for e.g. 2 seconds to produce an aerosol and a flavour containing aerosol generating material may be heated for e.g. 5 to 7 seconds. These two times for these two different aerosol generating materials different due to the energy required to sufficiently heat the flavour containing aerosol generating material.

In an example, a first heating element heats a first material within the aerosol generating material 112 at a first power level and a second heating element heats a second material within the aerosol generating material 112 at a second power level, wherein the first power level and the second power level are different power levels. This further enables greater personalisation of a produced aerosol. As the aerosol released will be related to the power at which the heater 124 operates, flavours can be released at different times in the session which, as above, leads to a level of control over the production of different notes within the smoking session.

The power level may be related to the power at which the specific heating element is operated, the rate of heat delivery or the temperature that the heater 124 reaches during the heating phase.

In an example, the default heating profile may heat for 10 seconds to a temperature of 140 degrees and then ramp to a pre-set operating temperature, T1-T4, which could be 160, 170, 180, 190 or 200 degrees Celsius respectively. This operating temperature is then held for a fixed period of time, determine by that which is being heated, and then return to its initial hold temperature until the next puff.

In an example, the aerosol generating material 112 may be in the form of at least one of a gel and a solid. A gel or a solid, unlike a liquid, would not require a reservoir to be contained within and as such reduces the cost of the device overall, by removing the requirement for an additional component. In general, the lack of requirement of the reservoir reduces the complexity of the AP system 100 presented herein. Furthermore, the construction of the cartridge may be less complex when the material is in a gel or solid form.

In some embodiments, the aerosol generating material comprises one or more polyhydric alcohols, such as propylene glycol, triethylene glycol, 1 ,3-butanediol and glycerin; esters of polyhydric alcohols, such as glycerol mono-, di-or triacetate; and/or aliphatic esters of mono-, di- or polycarboxylic acids, such as dimethyl dodecanedioate and dimethyl tetradecanedioate.

In embodiments where the aerosol generating material comprises a gel, the gel may comprise a gelling agent.

The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In some embodiments, the aerosol generating material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

In certain embodiments, the aerosol generating material comprises a gelling agent comprising a cellulosic gelling agent and/or a non-cellulosic gelling agent, an active substance and an acid.

In some embodiments, the aerosol generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol generating material may comprise one or more cannabinoid compounds selected from the group consisting of cannabidiol (CBD) and THC (tetrahydrocannabinol).

The aerosol generating material may comprise cannabidiol (CBD).

The aerosol generating material may comprise nicotine and cannabidiol (CBD).

The aerosol generating material may comprise nicotine, cannabidiol (CBD), and THC (tetrahydrocannabinol).

In some embodiments, the non-combustible aerosol provision system is an electronic cigarette, also known as a vaping device or electronic nicotine delivery system (END), although it is noted that the presence of nicotine in the aerosolisable material is not a requirement.

In some embodiments, the non-combustible aerosol provision system is a tobacco heating system, also known as a heat-not-burn system.

In some embodiments, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In some embodiments, the hybrid system comprises a liquid or gel aerosolisable material and a solid aerosolisable material. The solid aerosolisable material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the non-combustible aerosol provision device may comprise a power source and a controller. The power source may, for example, be an electric power source.

In some embodiments, the article for use with the non-combustible aerosol provision device may comprise an aerosolisable material, an aerosol generating component, an aerosol generating area, a mouthpiece, and/or an area for receiving aerosolisable material.

In some embodiments, the aerosol generating component is a heater capable of interacting with the aerosolisable material so as to release one or more volatiles from the aerosolisable material to form an aerosol.

In some embodiments, the substance to be delivered may be an aerosolisable material. Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants. In some embodiments, the aerosolisable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosolisable material may for example comprise from about 50 wt %, 60 wt % or 70 wt % of amorphous solid, to about 90 wt %, 95 wt % or 100 wt % of amorphous solid.

In examples, the amorphous solid may comprise a setting agent. The setting agent may comprise or consist of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate. It has been identified that, typically, employing calcium formate as a setting agent results in an amorphous solid having a greater tensile strength and greater resistance to elongation.

The amorphous solid may comprise a colourant. The addition of a colourant may alter the visual appearance of the amorphous solid. The presence of colourant in the amorphous solid may enhance the visual appearance of the amorphous solid and the aerosol-generating material. By adding a colourant to the amorphous solid, the amorphous solid may be colour-matched to other components of the aerosol-generating material or to other components of an article comprising the amorphous solid.

A variety of colourants may be used depending on the desired colour of the amorphous solid. The colour of amorphous solid may be, for example, white, green, red, purple, blue, brown or black. Other colours are also envisaged. Natural or synthetic colourants, such as natural or synthetic dyes, food-grade colourants and pharmaceutical-grade colourants may be used. In certain embodiments, the colourant is caramel, which may confer the amorphous solid with a brown appearance. In such embodiments, the colour of the amorphous solid may be similar to the colour of other components (such as tobacco material) in an aerosol-generating material comprising the amorphous solid. In some embodiments, the addition of a colourant to the amorphous solid renders it visually indistinguishable from other components in the aerosol-generating material.

The colourant may be incorporated during the formation of the amorphous solid (e.g. when forming a slurry comprising the materials that form the amorphous solid) or it may be applied to the amorphous solid after its formation (e.g. by spraying it onto the amorphous solid).

The aerosolisable material may comprise one or more active constituents, one or more carrier constituents and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, or any other suitable constituent. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, cooling agents, heating agents, or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

In some embodiments, the article for use with the non-combustible aerosol provision device may comprise aerosolisable material or an area for receiving aerosolisable material. In some embodiments, the article for use with the non-combustible aerosol provision device may comprise a mouthpiece. The area for receiving aerosolisable material may be a storage area for storing aerosolisable material. For example, the storage area may be a reservoir. In some embodiments, the area for receiving aerosolisable material may be separate from, or combined with, an aerosol generating area.

Thus there has been described an aerosol provision (AP) system comprising: a consumable comprising a plurality of aerosol generating material portions; an aerosol generator operable to generate an aerosolised payload by providing a predetermined heating profile to at least one of the plurality of aerosol generating material portions; wherein the predetermined heating profile is at least one of: pre-programmed in a controller of the AP system; and selected based on a coded portion of the consumable.

The aerosol (or vapour) provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a gel or a solid, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise a vapour or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In one embodiment, a system is provided comprising the AP system as per any of the embodiments described herein, together with a substrate identification means that comprises an input mechanism (such as a user input or a camera, as described previously herein) operable to receive an identifier corresponding to a substrate type; a configuration obtaining means (such as local memory or communication means to access remote memory in an associated phone or networked storage) operable to obtain data indicating the configuration of the plurality of dots of aerosolisable material on the identified substrate type; and a control setting means (such as the AP system control unit, or the CPU of an associated mobile phone) operable to modify heating control of at least two of the plurality of dots of aerosolisable material in response to the indicated configuration of the substrate.

The AP system itself may comprise the substrate identification means, or a mobile phone may comprise the substrate identification means, whilst the AP system comprises a wireless communication means (such as BlueTooth®) operable to communicate with the mobile phone.

In order to address various issues and advance the art, the entirety of this disclosure shows by way of illustration various embodiments in which the claimed invention(s) may be practiced and provide for a superior electronic vapour provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision (AP) device comprising:
a chamber for receiving a consumable which comprises aerosol generating material and one or more susceptors;
an aerosol generator operable to generate an aerosolised payload by providing one or more predetermined heating profiles to the aerosol generating material, wherein the aerosol generator comprises a first heater comprising one or more magnetic field generators for generating a varying magnetic field, and a second heater comprising an electrically resistive heating element; and
a controller, wherein the controller is configured to select the one or more predetermined heating profiles based on a response of the one or more susceptors from an interaction between the one or more susceptors and the varying magnetic field generated by the one or more magnetic field generators.

2. The AP device according to claim 1, wherein the controller is configured to cause the aerosol generator to begin providing the one or more predetermined heating profiles in response to the interaction between the one or more susceptors and the varying magnetic field, if the consumable is recognised based on the interaction between the one or more susceptors and the varying magnetic field.

3. The AP device according to claim 2, wherein the controller is configured to not cause the aerosol generator to begin providing the one or more predetermined heating profiles in response to the interaction between the one or more susceptors and the varying magnetic field, if the consumable is not recognised based on the interaction between the one or more susceptors and the varying magnetic field.

4. The AP device according to claim 1, wherein the one or more predetermined heating profiles comprises a plurality of predetermined heating profiles, the plurality of predetermined heating profiles comprising a first predetermined heating profile and a second predetermined heating profile, wherein the first predetermined heating profile is different from the second heating profile.

5. The AP device according to claim 4, wherein the first predetermined heating profile heats at a first power level and the second predetermined heating profile heats at a second power level, wherein the first power level is different from the second power level.

6. The AP device according to claim 4, wherein the first predetermined heating profile heats for a first time period and the second predetermined heating profile heats for a second time period, wherein the first time period is different from the second time period.

7. The AP device according to claim 4, wherein the first predetermined heating profile heats according to first heating curve and the second predetermined heating profile heats according to second heating curve, wherein the first heating curve is different from the second heating curve.

8. The AP device according to claim 4, wherein the controller is configured to select the first predetermined heating profile and the second predetermined heating profile based on a response of the one or more susceptors from the interaction between the one or more susceptors and the varying magnetic field generated by the one or more magnetic field generators.

9. The AP device according to claim 8, wherein the controller is configured to cause the first heater to provide the first predetermined heating profile to the aerosol generating material, and cause the second heater to provide the second predetermined heating profile to the aerosol generating material.

10. The AP device according to claim 9, wherein the controller is configured to cause the first heater to provide the first predetermined heating profile to the aerosol generating material, and cause the second heater to provide the second predetermined heating profile to the aerosol generating material, with a delay between starting providing the first predetermined heating profile and starting providing the second predetermined heating profile.

11. The AP device according to claim 9, wherein the controller is configured to cause the first heater to provide the first predetermined heating profile to the aerosol generating material, and cause the second heater to provide the second predetermined heating profile to the aerosol generating material, such that the first predetermined heating profile and the second heating profile are provided at least partly at the same time.

12. The AP device according to claim 1, wherein the one or more susceptors is a first coded portion of the consumable, and the consumable comprises a second coded portion, the AP device comprising a sensor configured to detect the second coded portion.

13. The AP device according to claim 12, wherein the controller is configured to select the one or more predetermined heating profiles based on detecting of the second coded portion by the sensor and the response of the one or more susceptors from the interaction between the one or more susceptors and the varying magnetic field generated by the one or more magnetic field generators.

14. The AP device according to claim 1, wherein the first heater and the second heater are arranged such that at least a quantity of the aerosol generating material is heated by both the first heater and the second heater.

15. The AP device according to claim 1, wherein the controller is configured to cause the aerosol generator to provide the selected one or more predetermined heating profiles to the aerosol generating material in response to activation of an activation mechanism of the AP device by a user.

16. The AP device according to claim 15, wherein the activation mechanism comprises a button.

17. The AP device according to claim 1, wherein the first heater and the second heater are configured to heat the aerosol generating material in a solid form.

18. The AP device according to claim 1, wherein the first heater and the second heater are configured to heat the aerosol generating material comprising tobacco.
